(19) United States
(12) Patent Application Publication
(10) Pub. No.: US 2026/0252788 A1
(43) Pub. Date: Aug. 27, 2026

(54) DISENTANGLING DESIGN ELEMENTS FOR CODE COMPONENT GENERATION

(71) Applicant: Adobe Inc., San Jose, CA (US)

(72) Inventors: Paul-Bogdan JURCUT, Lausanne (CH); Mustafa Doga DOGAN, Basel (CH); Lenard-Levente PALKO, Pratteln (CH); Christian MEYER, Mulhouse (FR); Adrian KOZMA, Rheinfelden (CH)

(21) Appl. No.: 19/061,131

(22) Filed: Feb. 24, 2025

(51) Int. Cl. G06F 40/143

(52) U.S. Cl. CPC G06F 40/143

(57) ABSTRACT

code components by disentangling content, structure, and style. In accordance with some aspects, content is extracted from a UI design file for a UI design generated using an interface design application. Structure data is inferred from a screenshot of the UI design. Additionally, style data is extracted from the UI design file. Structure code is generated using the structure data, styling code is generated using the style data, and the structure code and the styling code are stored in a code repository as code components for the UI design.

### BACKGROUND

Front-end development focuses on creating the user-facing side of a website or application. It generally involves designing and coding the user interfaces (UIs), including the visual and interactive elements that users engage with, such as buttons, navigation menus, forms, and animations. Interface design applications, such as the Figma design application, are often used to create high-fidelity prototypes and mockups of a website or application's interface. These interface design applications allow designers to generate UI designs without writing code. However, to make these UI designs functional, they must be converted into code. In some cases, this involves developers taking the UI designs and using languages like hypertext markup language (HTML), cascading style sheets (CSS), and JavaScript to write code, with the goal of providing code that renders UIs that match the designs and are responsive across various devices and screen sizes.

### SUMMARY

Some aspects of the present technology relate to, among other things, technologies for automatically converting user interface (UI) designs into functional code components by disentangling content, structure, and style. Given a UI design file for a UI design, a design conversion system extracts content from the UI design file, which includes visual and informational elements such as text, images, icons, videos, and graphics. The content can be stored as separate content items to allow for independent management of the content items in the design-to-code conversion process. The design conversion system also infers structure data from a screenshot of the UI design. This structure data captures the layout of the UI design, ensuring accuracy and responsiveness by focusing on the arrangement and organization of visual elements. The structure data is used to generate structure code, which provides a structured organization of elements from the UI design. The design conversion system also extracts style data from the UI design file, encompassing aspects such as fonts, colors, and borders. This style data is used to generate styling code that applies the visual aesthetics and creative aspects of the UI design. The generated structure code and styling code can be stored as code components in a code repository, facilitating efficient management and deployment of the code for the UI design.

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

### BRIEF DESCRIPTION OF THE DRAWINGS

The present technology is described in detail below with reference to the attached drawing figures, wherein:

FIG. 1 is a block diagram illustrating an exemplary system in accordance with some implementations of the present disclosure;

FIG. 2 is a diagram illustrating an example prompt for instructing an AI agent to generate a layout description from a screenshot of a UI design in accordance with some implementations of the present disclosure;

FIG. 3 is a diagram illustrating an example prompt for instructing an AI agent to generate a decorator function based on a layout description of a UI design in accordance with some implementations of the present disclosure;

FIG. 4 is a diagram illustrating an example prompt for instructing an AI agent to generate a CSS stylesheet in accordance with some implementations of the present disclosure;

FIG. 5 is a block diagram illustrating an example process of converting a UI design file to code in accordance with some implementations of the present disclosure;

FIG. 6 is a flow diagram showing an example method for generating code from a UI design file for a UI design in accordance with some implementations of the present disclosure;

FIG. 7 is a flow diagram showing another example method for generating code from a UI design file for a UI design in accordance with some implementations of the present disclosure; and

FIG. 8 is a block diagram of an exemplary computing environment suitable for use in implementations of the present disclosure.

### DETAILED DESCRIPTION

### Definitions

Various terms are used throughout this description. Definitions of some terms are included below to provide a clearer understanding of the ideas disclosed herein.

As used herein, the term “user interface” (UI) refers to the point of interaction between a user and a digital product, such as a website or other application. It encompasses the visual and interactive elements that allow users to interact with the digital product, such as to view information, navigate, input data, and perform tasks. UI elements can include, for instance, images, text, buttons, menus, icons, forms, sliders, and text fields, to name a few.

The term “UI design” is used herein to refer to a mockup or prototype of a UI created using an interface design application, such as the Figma application. A UI design is a visual representation of a UI, showcasing the layout and styling of elements without underlying functionality (or only minimal functionality such as linking between two UI designs). A UI design does not provide fully functioning code that can be implemented to provide a UI for a digital product. The digital data embodying a UI design created using an interface design application can be stored in a UI design file.

As used herein, “content” refers to the visual and informational elements within a UI design, such as text, images, icons, videos, and graphics. A “content item” refers to a single instance of content, such as an individual text portion or image. A UI design file can include multiple content items that are presented as part of the UI design.

“Structure” (sometimes referred to as “layout”) is used herein to refer to the arrangement and organization of visual elements within a UI design. The structure defines how the visual elements are positioned and aligned relative to one another to create a cohesive UI design. In accordance with some aspects of the technology described herein, “structure data” capturing the structure of a UI design is inferred from the screenshot of the UI design as part of the design-to-code conversion process. In some aspects, the structure data comprises a “layout description” that provides a textual representation of the structure. A layout description can include, for instance, text identifying elements in the UI design, text identifying relationships among the elements, and/or text identifying a role of each of the elements in the UI design.

The term “screenshot” is used herein to refer to a visual representation of a UI design in the form of an image. The image could represent, for instance, a tensor of values describing how the UI design looks.

As used herein, “style” refers to the visual aesthetics and creative aspects that define the overall look and feel of a UI design. Style encompasses aspects such as fonts, colors, and borders. In accordance with some aspects of the technology described herein, “style data” comprising digital data stored as part of a UI design file regarding the style of the UI design is extracted from the UI design file as part of the design-to-code conversion process.

The term “code component” is used herein to refer to code for a UI. A code component can provide code for a portion of a UI (e.g., a header) or can provide code for an entire UI. Code components can be written in languages such as hypertext markup language (HTML), cascading style sheets (CSS), JavaScript, and TypeScript. It should be noted that these are provided by way of example only, and other languages could be used. In accordance with some aspects of the technology described herein, code components are automatically generated from UI designs by a design conversion system that disentangles content, structure, and style from the UI designs to provide the code components.

“Structure code” refers to code that provides the structure of a UI, organizing elements such as headings, paragraphs, images, links, tables, forms, and buttons. The structure code provides for the arrangement of the elements that defines how the elements should act in terms of responsiveness. By way of example only and not limitation, the structure code could be provided by Flexbox in CSS, which provides for horizontal and vertical alignments, whether images should overflow, whether the structure should be a grid, etc. The structure code identifies the elements for the UI and their hierarchical relationship to one another, typically without controlling how the elements look. In accordance with some aspects of the technology described herein, the design-to-code conversion process involves generating a decorator function (e.g., a JavaScript decorator function) based on a layout description of a UI design such that when the decorator function is applied to an input block of HTML, it converts the input block of HTML, for instance, by adding classes, restructuring elements, and/or implementing functionalities.

“Styling code” refers to code that applies style to a UI. For example, the styling code can be written using languages such as CSS (Cascading Style Sheets) to specify how elements of a UI should look, including their colors, fonts, and sizing.

As used herein, the term “prompt” refers to textual input to an artificial intelligence (AI) agent to generate an output, including code. In some aspects, a prompt can comprise natural language text that guides or otherwise instructs the AI agent in generating the output.

An “AI agent” is a type of machine learning model, such as a generative model, that learns to generate output digital content from a given training dataset. Unlike discriminative models, which focus on predicting a label or class for input data, generative models aim to understand the underlying distribution of the data in order to generate output digital content. The AI agents used herein generate output digital content by sampling from this learned distribution, in order to perform tasks like language understanding and text synthesis. An AI agent can comprise a neural network model (i.e., an artificial neural network). In some cases, an AI agent can be multimodal by operating on inputs and/or generating outputs of different modalities, such as text, image, audio, and video. The AI agents described herein can provide for an agentic workflow that automates conversion of UI design files to code.

### Overview

This technology relates to automating the process of converting UI design files (e.g., from interface design applications such as the Figma design application) into functional, reusable code components. Currently, UI designs often lack sufficient information about responsive behavior, functionality, and layout structure, which makes automated conversion to code challenging. Designers who work on these tools do not necessarily think in terms of code structure, and developers are often required to manually interpret and translate UI design files into code. This process is repetitive, time-consuming, and subject to human error.

Previous approaches to automate the conversion of UI designs to code components include, for instance, using artificial intelligence (AI) techniques or static heuristics. However, these approaches have a number of shortcomings. For instance, they both rely on user-grouped elements, and the static heuristics require much more information from the user. The approaches often fail to create responsive designs and lack the flexibility for developers to intervene and customize the code. One current approach uses AI to convert designs into JSON structure and then translates that into code using a compiler. While this process generates code similar to how a developer would write it, it is tightly coupled with a specific model and approach, limiting flexibility and adaptability.

Aspects of the technology described herein provide an improved approach to automatic conversion of UI designs to code components that involves disentangling content, structure, and style during the conversion process. Given a design file for a UI design, a design conversion system described herein extracts content from the design file and stores the content separately. Additionally, the design conversion system accesses a screenshot of the UI design and infers structure from the screenshot independent from the styling, which allows for more flexibility. Style data is separately extracted from the design file and used to apply styling. This modular approach provides the ability to modify the content, structure, and style independently, making the system more adaptable, reusable, and customizable for developers without overwhelming the structural generation with styling information. This approach addresses challenges in existing solutions related to adaptability, responsiveness, and developer intervention while ensuring an efficient front-end development process and minimizing redundancy and human error.

In accordance with some aspects, given a UI design file, content extraction is performed, focusing on isolating the visual and informational elements within the UI design. This can comprise identifying and extracting content items such as text, images, icons, videos, and graphics from the UI design file. In some aspects, the extracted content items are stored independently (e.g., in a content management system), thereby allowing for dynamic updates and modifications without affecting the overall design or structure of the UI. This modular approach ensures greater flexibility and adaptability in managing UI elements, facilitating a more streamlined and efficient development process.

The generation of structure code for a UI design involves creating a representation of the UI design's layout and organization. This process can involve analyzing a screenshot of the UI design to infer the hierarchical relationships and arrangement of visual elements. By focusing on the actual appearance of the UI, rather than relying on potentially inaccurate metadata, the system ensures that the generated code accurately reflects the intended design. This approach enhances the responsiveness and adaptability of the UI across different devices and screen sizes.

In some aspects, the structure code is generated using advanced machine learning techniques, including AI agents that infer structure data and generate structure code from the inferred structure data. For instance, a first AI agent can analyze the screenshot of a UI design and generate a layout description that comprises text describing the structure of the UI design. A second AI agent then uses the layout description to produce structure code that organizes the UI elements into a coherent and functional layout. The generated structure code captures the relationships between elements, ensuring that the final layout is both accurate and responsive. This modular approach allows developers to update the structure independently of content and style, providing greater flexibility and customization options.

Styling code generation involves applying the visual aesthetics and creative aspects of the UI design. This process involves extracting style data from the UI design file, which includes fonts, colors, borders, and other styling attributes, and generating styling code based on the extracted style data. By separating style from content and structure, the system allows for independent modifications to the visual appearance of the UI. This separation enhances the customization options available to developers, enabling them to update the look and feel of the UI without altering its functionality.

In some aspects, the styling code is generated using predefined rules and/or AI agents that analyze the extracted style data. These approaches produce code that applies the desired visual aesthetics to the UI elements, ensuring that the final output matches the original design's appearance. The generated styling code can be easily integrated with the structure code, providing a cohesive and visually appealing UI. This modular approach allows for dynamic updates to the UI's style, ensuring that changes in visual design do not disrupt the underlying structure or content.

Aspects of the technology described herein provide a number of improvements over existing technologies for design-to-code conversion. For instance, the technology described herein goes beyond simple HTML and CSS generation by employing a process of disentanglement. As described herein, the solution involves separating the content, layout, and styling into independent, modular components. Among other things, this facilitates use in CMS environments, where content needs to be easily interchangeable and adaptable without breaking the entire design. The ability to manage these elements separately provides for scalability and flexibility, and is not addressed by the simple approach used by conventional design-to-code tools.

Another advantage of this technology is the inference of structure from screenshots of UI designs. While some interface design applications offer layout features such as auto-layout, these features are often underused or misused by designers. Additionally, designers may not follow best practices, leading to incomplete or incorrect layout data in the design files. By using screenshots and employing an AI agent to infer the correct layout, this limitation is bypassed, which ensures that the generated structure code accurately reflects the designer's intent, even if internal layout data is inconsistent or missing. This layout inference provides flexibility for designers, allowing them to focus on creativity rather than technical correctness. They can simply arrange elements on the screen without worrying about using layout features properly, and the system will still generate a fully responsive and well-structured layout, which can adapt to different display sizes, i.e., desktop, tablet, and mobile.

A further advantage of this technology is that, unlike existing tools that attempt to generate all code in a single step, the design conversion system described herein employs a modular approach in which content, layout, styling, and potentially even functionality are handled separately, for instance, using different AI agents performing different tasks. This division of tasks ensures that each element is generated with high precision and flexibility, and also allows for the integration of JavaScript for dynamic functionality —something conventional solutions overlook. This modularity makes the design conversion system described herein far more adaptable to changes. For example, if the designer decides to update the content, the layout and styling remain unaffected. If styling needs to be changed, content and layout remain intact. This level of flexibility facilitate use in large-scale design systems and CMS applications.

### Example System for Converting Design Files to Code Components

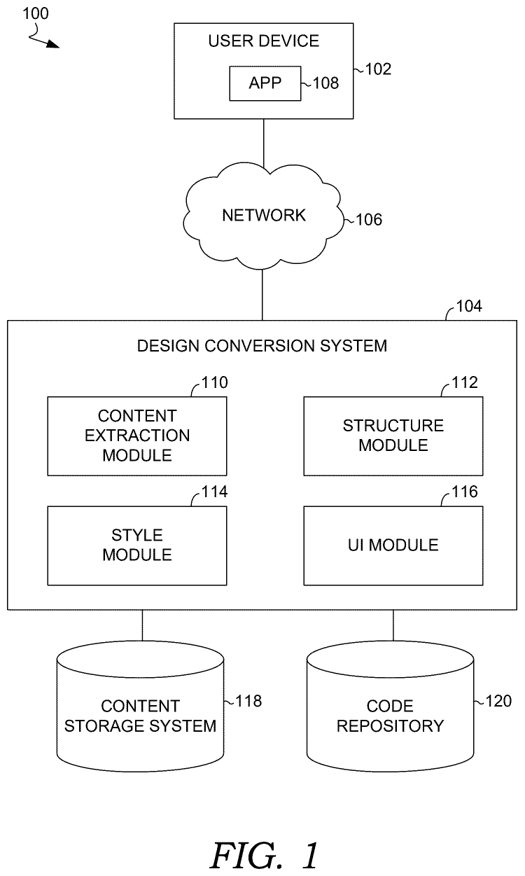

With reference now to the drawings, FIG. 1 is a block diagram illustrating an exemplary system 100 for converting UI design files to code components in accordance with implementations of the present disclosure. It should be understood that this and other arrangements described herein are set forth only as examples. Other arrangements and elements (e.g., machines, interfaces, functions, orders, and groupings of functions, etc.) can be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, various functions may be carried out by a processor executing instructions stored in memory.

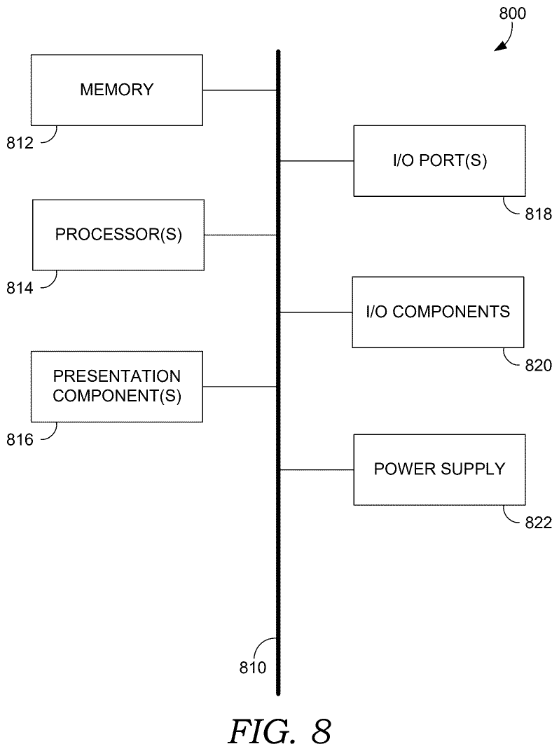

The system 100 is an example of a suitable architecture for implementing certain aspects of the present disclosure. Among other components not shown, the system 100 includes a user device 102 and a design conversion system 104. Each of the user device 102 and the design conversion system 104 shown in FIG. 1 can comprise one or more computer devices, such as the computing device 800 of FIG. 8, discussed below. As shown in FIG. 1, the user device 102 and the design conversion system 104 can communicate via a network 106, which may include, without limitation, one or more local area networks (LANs) and/or wide area networks (WANs). Such networking environments are commonplace in offices, enterprise-wide computer networks, intranets, and the Internet. It should be understood that any number of user devices and servers may be employed within the system 100 within the scope of the present technology. Each may comprise a single device or multiple devices cooperating in a distributed environment. For instance, the design conversion system 104 could be provided by multiple server devices collectively providing the functionality of the design conversion system 104 as described herein. Additionally, other components not shown may also be included within the network environment.

The user device 102 can be a client device on the client-side of the system 100, while the design conversion system 104 can be on the server-side of the system 100. The design conversion system 104 can comprise server-side software designed to work in conjunction with client-side software on the user device 102 so as to implement any combination of the features and functionalities discussed in the present disclosure. For instance, the user device 102 can include an application 108 for interacting with the design conversion system 104. The application 108 can be, for instance, a web browser or a dedicated application for providing functions, such as those described herein. This division of the system 100 is provided to illustrate one example of a suitable environment, and there is no requirement for each implementation that any combination of the user device 102 and the design conversion system 104 remain as separate entities. While the system 100 illustrates a configuration in a networked environment with a separate user device and design conversion system, it should be understood that other configurations can be employed in which aspects of the various components are combined. For instance, in some aspects, aspects of the design conversion system 104 can be implemented in part or in whole by the user device 102.

The user device 102 can comprise any type of computing device capable of use by a user. For example, in one aspect, the user device 102 may be the type of computing device 800 described in relation to FIG. 8 herein. By way of example and not limitation, the user device 102 can be embodied as a personal computer (PC), a laptop computer, a mobile or mobile device, a smartphone, a tablet computer, a smart watch, a wearable computer, a personal digital assistant (PDA), an MP3 player, global positioning system (GPS) or device, video player, handheld communications device, gaming device or system, entertainment system, vehicle computer system, embedded system controller, remote control, appliance, consumer electronic device, a workstation, or any combination of these delineated devices, or any other suitable device. A user can be associated with the user device 102 and can interact with the design conversion system 104 via the user device 102. The user can be, for instance, an individual responsible for generating a UI design and/or code for a UI from a UI design, such as a front-end designer or developer.

The design conversion system 104 provides for automatic conversion of UI design files to code components by disentangling content, structure, and style from the UI designs. As shown in FIG. 1, the design conversion system 104 includes a content extraction module 110, a structure module 112, a style module 114, a functionality module 116, and a user interface module 118. The modules/components of the design conversion system 104 may be in addition to other modules/components that provide further additional functions beyond the features described herein. The design conversion system 104 can be implemented using one or more server devices, one or more platforms with corresponding application programming interfaces, cloud infrastructure, and the like. While the design conversion system 104 is shown separate from the user device 102 in the configuration of FIG. 1, it should be understood that in other configurations, some or all of the functions of the design conversion system 104 can be provided on the user device 102. Additionally, in some configurations, one or more of the components of the design conversion system 104 shown in FIG. 1 can be provided by the user device 102 and/or another location not shown in FIG. 1. The components can be provided by a single entity or multiple entities.

In some aspects, the functions performed by modules/components of the design conversion system 104 are associated with one or more applications, services, or routines. In particular, such applications, services, or routines may operate on one or more user devices, servers, may be distributed across one or more user devices and servers, or be implemented in the cloud. Moreover, in some aspects, these modules/components of the design conversion system 104 may be distributed across a network, including one or more servers and client devices, in the cloud, and/or may reside on a user device. Moreover, these modules/components, functions performed by these modules/components, or services carried out by these modules/components can be implemented at appropriate abstraction layer(s) such as the operating system layer, application layer, hardware layer, etc., of the computing system(s). Alternatively, or in addition, the functionality of these modules/components and/or the aspects of the technology described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc. Additionally, although functionality is described herein with regards to specific modules/components shown in example system 100, it is contemplated that in some aspects, functionality of these modules/components can be shared or distributed.

The content extraction module 110 of the design conversion system 104 extracts content items from a UI design file and stores them in a content storage system 120. The content extraction module 110 focuses on identifying and isolating the visual and informational elements within the UI design, such as text, images, icons, videos, and graphics. By separating these content items from the structure and style of the UI design, the content extraction module 110 ensures that the content items can be managed independently, allowing for greater flexibility and adaptability in the design-to-code conversion process.

In some aspects, the content extraction module 110 operates by parsing a UI design file to identify individual content items. The content extraction module 110 can use, for instance, predefined rules and algorithms to extract the content items from the UI design file and store them in a structured format within the content storage system 120.

The content storage system 120 can be any structured storage that facilitates retrieval and reuse of content items, enabling dynamic updates and modifications to content items without affecting the overall design or structure of UIs. In some aspects, the content storage system 120 provides a retrieval mechanism that allows seamless access to the stored content items when needed for rendering UIs. The retrieval process ensures the flexibility of updating content independently from the structural design. By way of example only and not limitation, the content items can be stored in a content management system (CMS), such as the Adobe Experience Manager (AEM) platform. For instance, extracted content items can be stored as AEM content fragments. Storing the content in a CMS allows the content to be dynamically changed and managed in the CMS without affecting the structure or style of UI designs.

The structure module 112 infers structure data using a screenshot of a UI design and generates structure code from the structure data. The structure module 112 focuses on understanding the arrangement and organization of visual elements within the UI design, defining how these elements are positioned and aligned relative to one another. By inferring the structure data from a screenshot, the structure module 112 ensures that the final layout is accurate and responsive, as it is derived from the actual appearance of the UI design rather than potentially inaccurate metadata from the UI design file. The structure module 112 also accounts for responsiveness and adaptability, ensuring that the layout of the UI design can adjust to different screen sizes and orientations without compromising the UI design's integrity.

The structure module 112 uses image processing, natural language processing (NLP), and/or other machine learning techniques to analyze the screenshot of the UI design and generate the structure data. The structure module 112 identifies elements in the UI design and the hierarchical relationships between the different elements and creates the structure data that captures the layout of the UI design. In some aspects, the structure data comprises a textual description that provides a structured organization of elements within the UI design. The textual description can provide a representation of the relationships between elements, such as how they are nested and interact with one another, providing a blueprint for how the elements are arranged in the UI design. The structure module 112 can then generate the structure code to comport with the textual description of the structure for the UI design.

In some aspects, to generate the structure data for a UI design, the structure module 112 provides a screenshot of the UI design to an AI agent, causing the AI agent to generate a layout description as the structure data of the UI design. The layout description is a textual representation that captures the structure of the UI design, detailing the arrangement and relationships of visual elements within the UI design. In some configurations, the layout description provides a detailed and structured text description of the layout, including element types, hierarchy, and semantics. For instance, the layout description can comprise text identifying elements in the UI design, text identifying relationships among the elements, and/or text identifying a role of each of the elements in the UI design.

The layout description can be provided to an AI agent, which generates structure code based on textual description of the structure of the UI design provided by the layout description. In some aspects, the AI agent is provided the layout description and an input block of HTML, and the AI agent generates a decorator function based on those inputs. The decorator function is generated to modify the input block of HTML by adding classes, restructuring elements, and implementing functionalities in order to capture the structure of the UI design. In such configurations, the structure data comprises the input block of HTML and/or the decorator function.

The structure code generated by the structure module 112 can be stored in a code repository 122. The code repository 122 can comprise, for instance, a centralized storage location where developers keep, manage, and track their code and related files. In some aspects, the code repository 122 enables version control, allowing multiple developers to collaborate on a project by tracking changes, managing different versions of the code, and merging updates from different contributors. Examples of version control systems for code repositories include Git (used with platforms like GitHub, GitLab, and Bitbucket), Subversion (SVN), and Mercurial. The code repository 122 can help maintain a complete history of code changes, making it easier to roll back to previous versions and ensure collaboration across development teams.

The style module 114 of the design conversion system 104 extracts style data from a UI design file and generates styling code to capture the style of the UI design. The style module 114 focuses on capturing the visual aesthetics and creative aspects that define the overall look and feel of the UI design, such as fonts, colors, borders, and other styling attributes. By separating the style from the content and structure, the style module 114 ensures that changes to the UI design's appearance can be made independently of the content and structure, providing greater flexibility and customization options.

After extracting style data from a UI design file, the style module 114 generates styling code based on the extracted style data. The styling code comprises code that applies style to the UI. For example, the styling code can be written using languages such as CSS (Cascading Style Sheets) to specify how elements of the UI should look based on the style data. In some aspects, the style module 114 employs predefined rules for converting certain style data from UI design files to styling code. In other configurations, the style module 114 employs an AI agent that takes style data extracted from the UI design file as input and outputs styling code. In configurations in which the structure module 112 provides a layout description and a decorator function, the style module 114 can provide the extracted style data, layout description, and decorator function to the AI agent to generate the styling code. Once generated, the styling code can be stored in the code repository 122. For instance, the styling code can be stored as a CSS stylesheet.

The functionality module 116 of the design conversion system 104 extracts functionality data from a UI design file and provides functionality code for the UI design. For instance, the functionality module 116 can analyze the UI design to identify functionality associated with UI elements such as clickable buttons or carousels. In some aspects, the functionality module 116 employs predefined rules for identifying functional elements from UI design files and generating functionality code for those elements. In other configurations, the functionality module 116 employs an AI agent that takes data extracted from the UI design file as input and outputs functionality code.

The AI agents used by the design conversion system 104 can comprise the same model or different models. Each AI agent employed can comprise, for instance, a language model that includes a set of statistical or probabilistic functions to perform NLP in order to understand, learn, and/or generate human natural language text and code. For example, a language model can be a tool that determines the probability of a given sequence of words occurring in a sentence, natural language sequence, and/or code. A language model is called a large language model (LLM) when it is trained on enormous amount of data and/or has a large number of parameters. Some examples of LLMs are GOOGLE's BERT and OpenAI's GPT-4. These models have capabilities ranging from writing a simple essay to generating complex computer codes-all with limited to no supervision. Accordingly, an LLM can comprise a deep neural network that is very large (e.g., billions to hundreds of billions of parameters) and understands, processes, and produces human natural language and code by being trained on massive amounts of text. These models can predict future words in a sequence letting them, for instance, generate sentences similar to how humans talk and write or otherwise in a form dictated, for instance, by a prompt.

In accordance with some aspects, each AI agent employed by the design conversion system 104 comprises a neural network (i.e., an artificial neural network). As used herein, a neural network comprises multiple operational layers, including an input layer and an output layer, as well as any number of hidden layers between the input layer and the output layer. Each layer comprises neurons. Different types of layers and networks connect neurons in different ways. Neurons have weights, an activation function that defines the output of the neuron given an input (including the weights), and an output. The weights are the adjustable parameters that cause a network to produce a correct output.

In some configurations, each AI agent used by the design conversion system 104 can be a pre-trained model that has not been fined-tuned. In other configurations, each AI agent can be a model that is built and trained from scratch or a pre-trained model that has been fine-tuned. In such configurations, each AI agent can be trained or fine-tuned for a particular task using training data. For instance, the training data could comprise training samples, where each training sample can include input data and ground truth data. For example, a training sample for training an AI agent to generate layout descriptions can comprise a sample screenshot of a UI design paired with a sample layout description as ground truth data. As another example, a training sample for training an AI agent to generate structure code can comprise a sample layout description paired with a sample structure code as ground truth data. As yet another example, a training sample for training an AI agent to generate styling code can comprise a sample style data paired with a sample styling code as ground truth data.

During training, weights associated with each neuron can be updated. Originally, the model of an AI agent can comprise random weight values or pre-trained weight values that are adjusted during training. In one aspect, the model is trained using backpropagation. The backpropagation process comprises a forward pass, a loss function, a backward pass, and a weight update. For instance, a forward pass could comprise providing a sample input from a training sample to the AI agent, which generates an output. A loss could then be determined, for instance, based on the output and the ground truth data from the training sample, and weights of the model are updated based on the loss. This process is repeated using the training data. The goal is to update the weights of each neuron (or other model component) to cause the AI agent to produce useful output. Once trained, the weight associated with a given neuron can remain fixed. The other data passing between neurons can change in response to a given input. Retraining the network with additional training data can update one or more weights in one or more neurons.

Some aspects of the technology employ pre-configured prompts to instruct AI agents to perform certain tasks. For instance, a prompt provided to an AI agent used by the structure module 112 could provide instructions regarding the generation of a layout description from a screenshot of a UI design. Another prompt provided to an AI agent used by the structure module 112 could provide instructions regarding generating structure code based on the layout description. A further prompt provided to an AI agent used by the style module 114 could provide instructions regarding the generation of styling code from style data extracted form a UI design file.

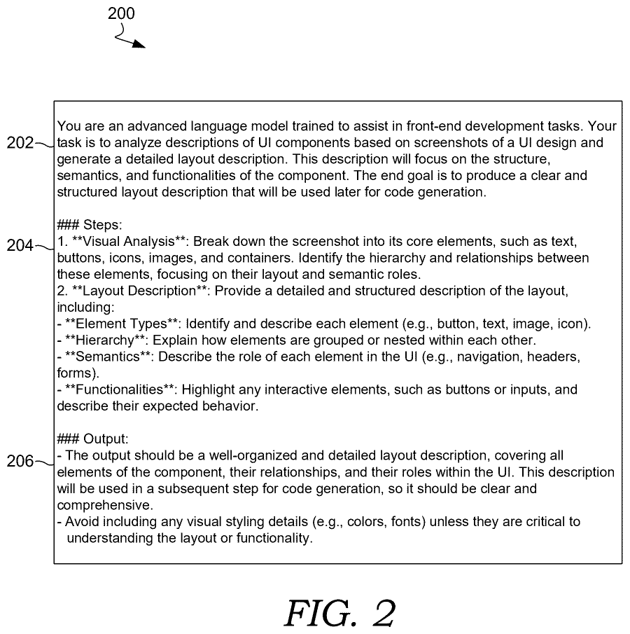

By way of illustration, FIGS. 2-4 provide example prompts that can be used in some implementations of the present technology. With initial reference to FIG. 2, an example prompt 200 is provided for instructing an AI agent to generate a layout description from a screenshot of a UI design. As shown in FIG. 2, the prompt 200 provides general information 202 describing the task to be performed.

The prompt 200 also includes instructions 204 regarding the steps for the AI agent to perform the task. The steps include performing a visual analysis of the screen shot by: breaking down the screenshot into its core elements, such as text, buttons, icons, images, and containers; and identifying the hierarchy and relationships between these elements, focusing on their layout and semantic roles. The steps also include generating a detailed and structured description of the layout of the UI design from the visual analysis. This includes instructions to: identify and describe each element (e.g., button, text, image, icon); explain how elements are grouped or nested within each other; describe the role of each element in the UI (e.g., navigation, headers, forms); and highlight any interactive elements, such as buttons or inputs, and describe their expected behavior.

Finally, the prompt 200 provides a description 206 of the output expected, which is described as a well-organized and detailed layout description, covering all elements of the component, their relationships, and their roles within the UI. The description 206 also instructs the AI agent that the layout description will be used in a subsequent step for code generation, so it should be clear and comprehensive. To facilitate the separation of style and content, the description 208 further instructs the AI agent to avoid including any visual styling details (e.g., colors, fonts) unless they are critical to understanding the layout or functionality.

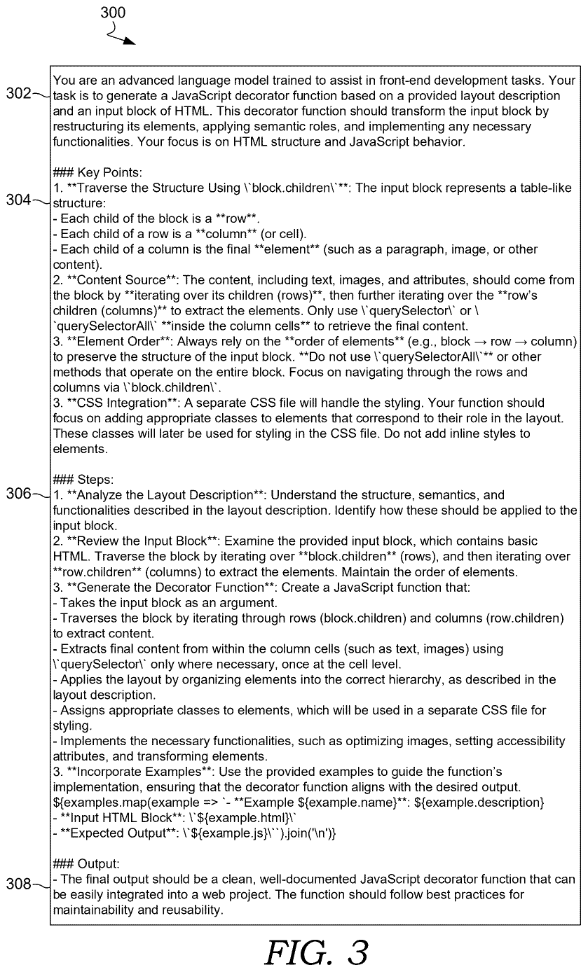

FIG. 3 provides an example prompt 300 for instructing an AI agent to generate a decorator function based on a layout description of a UI design and an input block of HTML. As shown in FIG. 3, the prompt 300 provides general information 302 describing the task to be performed. The prompt 300 also provides key points 304 regarding: how to traverse the input HTML structure; the content source; the element order; and CSS integration.

Next, the prompt 300 includes instructions 306 regarding the steps for the AI agent to perform the task. The steps include analyzing the layout description to understand the structure, semantics, and functionalities described in the layout description, as well as identifying how these should be applied to the input HTML. The next step is to review the input HTML, including traversing the HTML block by iterating over rows and columns to extract elements, while maintaining the order of the elements. After traversing the HTML block, the next step is to generate a decorator function. This step includes taking the input HTML block as an argument, traversing the HTML block to extract content, applying the layout by organizing elements into the correct hierarchy as described in the layout description, assigning appropriate classes to elements (which will be used in a separate CSS file for styling), and implementing functionalities (such as optimizing images, setting accessibility attributes, and transforming elements). The steps also instruct the AI agent to use examples to guide the generation of the decorator function.

Finally, the prompt 300 provides a description 308 of the output expected, which is described as a clean, well-documented JavaScript decorator function that can be easily integrated into a project. The description 308 also indicates that the decorator function should follow best practices for maintainability and reusability.

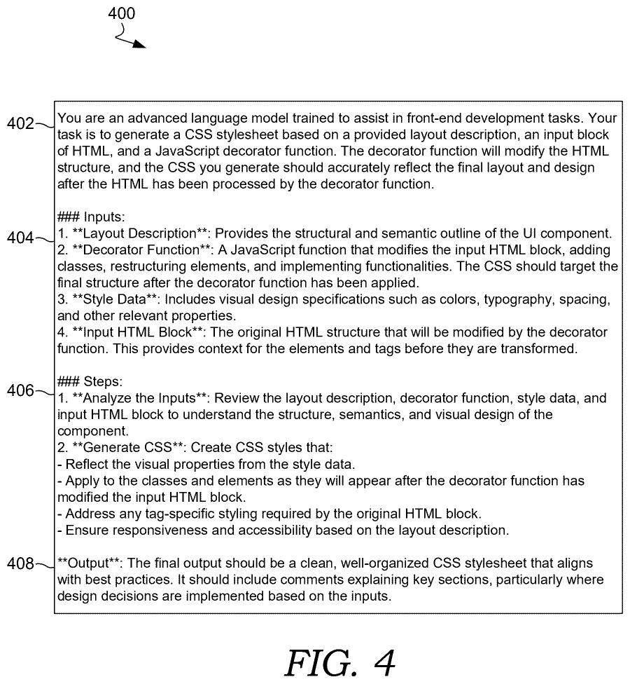

FIG. 4 provides an example prompt for instructing an AI agent to generate a CSS stylesheet using design data from a UI design file. As shown in FIG. 4, the prompt 400 provides general information 402 describing the task to be performed. The prompt 400 also provides information 404 regarding the inputs, which in this example includes: a layout description, a decorator function, style data, and an input HTML block.

The prompt 400 also includes instructions 406 regarding the steps for the AI agent to perform the task. The steps include analyzing the inputs to understand the structure, semantics, and visual design of the UI design. The steps also include generating CSS styles that: reflect the style data; apply to the classes and elements as they will appear after the decorator function has modified the input HTML block; address any tag-specific styling required by the original HTML block; and ensure responsiveness and accessibility based on the layout description.

Finally, the prompt 400 provides a description 408 of the output expected, which is described as a clean, well-organized CSS stylesheet that aligns with best practices and that also includes comments explaining key sections, for instance, where design decisions are implemented based on the inputs.

With reference again to FIG. 1, the design conversion system 104 also includes a UI module 118 that provides one or more user interfaces for users (e.g., designers and developers) to interact with the design conversion system 104. For instance, the UI module 118 provides one or more UIs to user devices, such as the user device 102. In some instances, the user interfaces can be presented on the user device 102 via the application 108, which can be a web browser or a dedicated application for interacting with the design conversion system 104. Among other things, the UI module 118 can provide user interfaces for interacting with the design conversion system 104 to facilitate the design-to-code process performed by the design conversion system 104. The user interfaces, for instance, can allow a user to provide a UI design file, as well as an additional input or prompting to instruct the conversion process. The user interfaces can also provide for the presentation of code components generated for UI design files to allow users to review and/or modify the generated code. The user interfaces can further provide for the presentation of UIs rendered from code components generated from UI design files by the design conversion system 104, allowing users to compare the rendered UIs to the UI designs. In configurations in which the code components for a UI design comprise an HTML block, decorator function, and CSS stylesheet, the UI can be rendered by processing the HTML using the decorator function to provide the structure of the UI and using the CSS stylesheet to apply styling. Additional functionality can also be injected into the UI, for instance, using JavaScript.

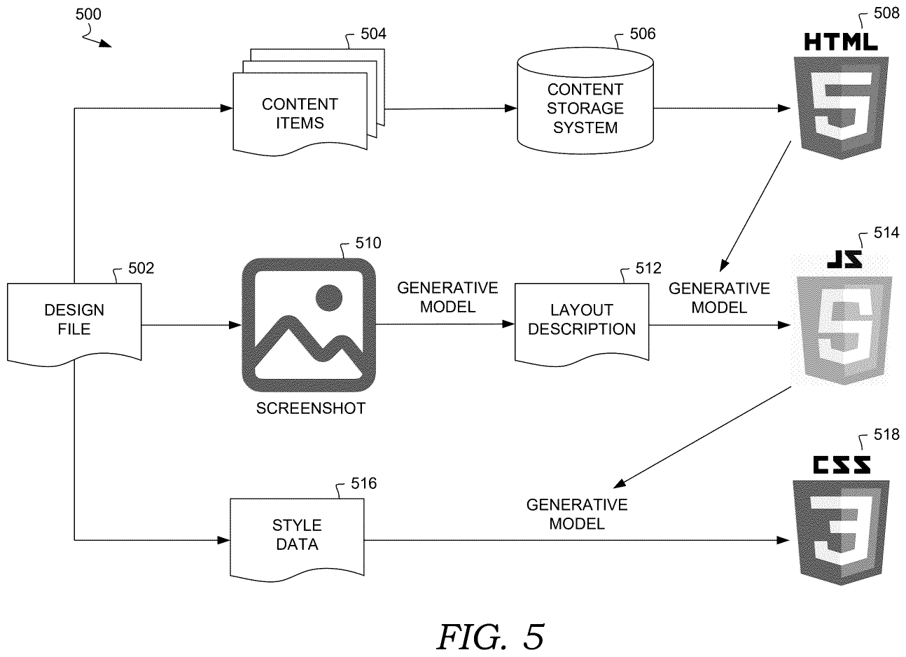

Turning next to FIG. 5, a block diagram is provided that illustrates an example process 500 of converting a UI design file to code. As shown in FIG. 5, a UI design file 502 (e.g., a Figma design file) is provided as initial input. Content items 504 are extracted from the UI design file 502, and the content items 504 are stored in a content storage system 506 as individual items. The extracted content items in the content storage system 506 can be used as example content input for a block of HTML 508.

Given a screenshot 510 of the UI design from the UI design file 502, an AI agent generates a layout description 512 providing a textual representation of the structure of visual elements as presented in the screenshot 510. Structure code 514 is then generated based on the layout description 512. In this example, the structure code 514 comprises a JavaScript decorator function generated by providing the layout description 512 and the block of HTML 508 to an AI agent that analyzes the inputs to generate the decorator function. The decorator function, when applied to the block of HTML 508, modifies the HTML by adding classes, restructuring elements, and implementing functionalities.

Style data 516 is also extracted from the UI design file 502, and styling code 518 is generated using the style data 520. In this example, the style data 516 and structure code 514 are provided as input to an AI agent, which analyzes the inputs to generate a CSS stylesheet as the styling code 518.

The technology described herein enables a wide variety of use cases for generating code components from UI designs. For instance, one example use case is the treatment of designs as content. In particular, the modular approach allows designs to be treated as content within a CMS, enabling designers to experiment with variations (e.g., for A/B testing) without disrupting the workflow. For instance, design information can be stored as JSON, allowing designers to push new variations, which the CMS dynamically references as content fragments. This reintegrates designers into the content management loop, giving them more control over design experimentation. The following describes how the workflow fits this use case.

Content Extraction: Design elements (text, images, layout) are extracted from a UI design file into content fragments. Here, modularity is provided as design elements are separated and stored independently, allowing for dynamic updates.

Content Storage & Retrieval: Extracted design data can be stored as JSON in the CMS (e.g., AEM) and made referenceable. Design variations are stored as separate content fragments, enabling authors to easily switch between them.

Component Creation: Modular code components are created that dynamically integrate different design JSONs, maintaining a flexible structure. This allows easy swapping of design variations without affecting the component's underlying functionality.

Style Injection: CSS styles are injected based on the design data from the UI design file, which ensures that the visual appearance matches the design. This provides modularity as styles can be changed dynamically by swapping the referenced design JSON, without altering the structure or content.

### Example Methods for Converting Design Files to Code Components

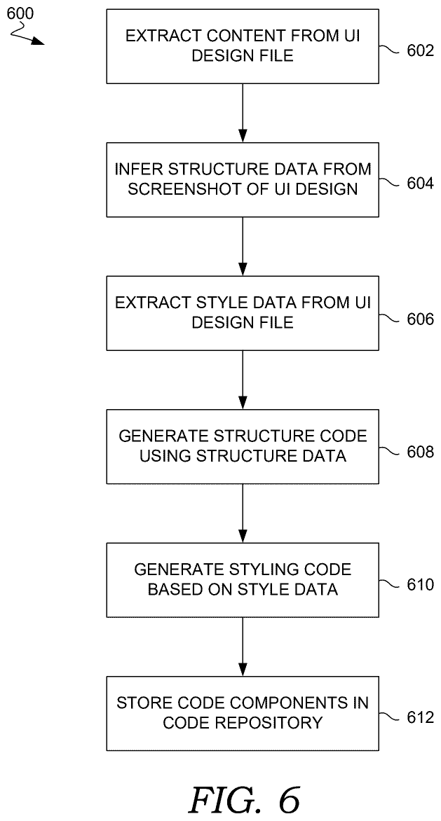

With reference now to FIG. 6, a flow diagram is provided that illustrates a method 600 for generating code from a UI design file for a UI design. The method 600 can be performed, for instance, at least in part by the design conversion system 104 of FIG. 1. Each block of the method 600 and any other methods described herein comprises a computing process performed using any combination of hardware, firmware, and/or software. For instance, various functions can be carried out by a processor executing instructions stored in memory. The methods can also be embodied as computer-usable instructions stored on computer storage media. The methods can be provided by a standalone application, a service or hosted service (standalone or in combination with another hosted service), or a plug-in to another product, to name a few.

As shown at block 602, content is extracted from a UI design file. This can involve extracting the visual and informational elements from the UI design file, such as text, images, icons, videos, and graphics. Each content item can be identified and isolated from the UI design file, for instance, using predefined rules. In some aspects, each content item is stored separately in a content storage system. This ensures that the content items can be managed independently, allowing for greater flexibility and adaptability in the design-to-code conversion process.

Structure data is inferred from a screenshot of the UI design, as shown at block 604. The structure data provides a representation that captures the layout of the UI design independent of content and style, ensuring accuracy and responsiveness. In some aspects, image processing and machine learning techniques are used to analyze the screenshot and determine the hierarchical relationships between different visual elements in the UI design. For instance, in some aspects, the screenshot is provided to an AI agent that is trained and/or prompted to analyze the screenshot and generate structure data in the form of a layout description comprising text describing the structure of the UI design.

As shown at block 606, style data is also extracted from the UI design file. The style data can include, for instance, fonts, colors, borders, and other styling attributes. This style data will be used to apply the visual aesthetics and creative aspects that define the overall look and feel of the UI design.

Structure code is generated using the structure data inferred from the screenshot of the UI design, as shown at block 608. The structure code captures the structure of the UI design without styling. In some aspects, the structure data is provided to an AI agent that is trained and/or prompted to analyze the structure data and generate code to provide a structured organization of elements from the UI design, ensuring that the final layout is accurate and responsive. The structure code can be written in languages such as HTML and JavaScript.

As shown at block 610, styling code is generated based on the style data extracted from the UI design file. The styling code can comprise, for instance, a CSS stylesheet. In some aspects, the styling code is generated using pre-defined rules to convert style data to styling code. In other aspects, the styling code is generated by providing the style data and the structure data to an AI agent that that is trained and/or prompted to analyze the style data and the structure data and generate the styling code.

The structure code and styling code are stored as code components in a code repository, as shown at block 612. The code repository makes the code components available for reuse and/or further development, allowing for efficient management and deployment of the code for the UI being designed. Although not shown in FIG. 6, the process can also include rendering a UI using the code components. For instance, a UI can be rendered using the generated code components and the content items to allow a designer or developer to compare the rendered UI with the UI design.

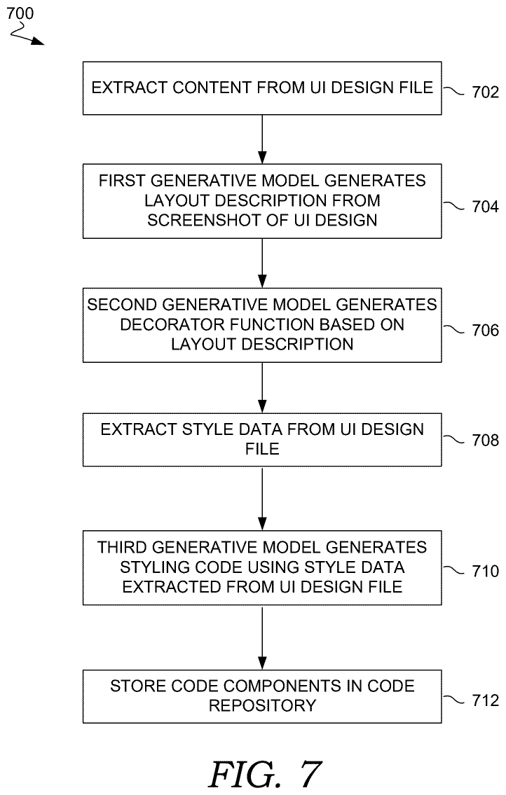

FIG. 7 is a flow diagram showing another example method for generating code from a UI design file for a UI design. The method 700 can be performed, for instance, at least in part by the design conversion system 104 of FIG. 1. As shown at block 702, content is extracted from a UI design file. This can involve extracting the visual and informational elements from the UI design file, such as text, images, icons, videos, and graphics. Each content item can be identified and isolated from the UI design file, for instance, using predefined rules. In some aspects, each content item is stored separately in a content storage system. This ensures that the content items can be managed independently, allowing for greater flexibility and adaptability in the design-to-code conversion process.

As shown at block 704, a first AI agent generates a layout description from a screenshot of the UI design. In particular, the screenshot is provided as input to the first AI agent, which is trained and/or prompted to analyze the screenshot and generate the layout description. The layout description provides a textual representation of the structure of the UI design, detailing the arrangement and relationships of visual elements. The layout description includes information, for instance, about element types, hierarchy, and semantics.

A second AI agent generates a decorator function based on the layout description, as shown at block 706. The layout description is provided as input to the second AI agent, which is trained and/or prompted to analyze the layout description and generate the decorator function. The decorator function comprises code (e.g., JavaScript) that modifies an input block of HTML by adding classes, restructuring elements, and implementing functionalities such that it aligns with the layout description.

Style data is extracted from the UI design file, as shown at block 708. The style data can include, for instance, fonts, colors, borders, and other styling attributes. A third AI agent generates styling code using the style data extracted from the UI design file, as shown at block 710. The styling code can be, for instance, a style sheet (e.g., a CSS stylesheet) that specifies styling properties such as fonts, colors, and spacing. In some aspects, the styling code is generated by the third AI agent based on the style data, the layout description, and input block of HTML, and the decorator function.

The structure code and styling code are stored as code components in a code repository, as shown at block 712. The code repository makes the code components available for reuse and/or further development, allowing for efficient management and deployment of the code for the UI being designed. Although not shown in FIG. 6, the process can also include rendering a UI using the code components. For instance, a UI can be rendered using the generated code components and the content items to allow a designer or developer to compare the rendered UI with the UI design. This can include using the decorator function to transform the input block of HTML by adding classes, restructuring elements, and implementing functionalities. The generated styling code is applied, ensuring that the final output matches the original design's visual aesthetics, for instance, by integrating the styling code with the HTML structure to create a cohesive and visually appealing UI component.

### Exemplary Operating Environment

Having described implementations of the present disclosure, an exemplary operating environment in which embodiments of the present technology may be implemented is described below in order to provide a general context for various aspects of the present disclosure. Referring initially to FIG. 8 in particular, an exemplary operating environment for implementing embodiments of the present technology is shown and designated generally as computing device 800. Computing device 800 is but one example of a suitable computing environment and is not intended to suggest any limitation as to the scope of use or functionality of the technology. Neither should the computing device 800 be interpreted as having any dependency or requirement relating to any one or combination of components illustrated.

The technology may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The technology may be practiced in a variety of system configurations, including hand-held devices, consumer electronics, general-purpose computers, more specialty computing devices, etc. The technology may also be practiced in distributed computing environments where tasks are performed by remote-processing devices that are linked through a communications network.

With reference to FIG. 8, computing device 800 includes bus 810 that directly or indirectly couples the following devices: memory 812, one or more processors 814, one or more presentation components 816, input/output (I/O) ports 818, input/output components 820, and illustrative power supply 822. Bus 810 represents what may be one or more busses (such as an address bus, data bus, or combination thereof). Although the various blocks of FIG. 8 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors recognize that such is the nature of the art, and reiterate that the diagram of FIG. 8 is merely illustrative of an exemplary computing device that can be used in connection with one or more embodiments of the present technology. Distinction is not made between such categories as “workstation,” “server,” “laptop,” “hand-held device,” etc., as all are contemplated within the scope of FIG. 8 and reference to “computing device.”

Computing device 800 typically includes a variety of computer-readable media. Computer-readable media can be any available media that can be accessed by computing device 800 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data.

Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 800. The terms “computer storage media” and “computer storage medium” do not comprise signals per se.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 812 includes computer storage media in the form of volatile and/or nonvolatile memory. The memory may be removable, non-removable, or a combination thereof. Exemplary hardware devices include solid-state memory, hard drives, optical-disc drives, etc. Computing device 800 includes one or more processors that read data from various entities such as memory 812 or I/O components 820. Presentation component(s) 816 present data indications to a user or other device. Exemplary presentation components include a display device, speaker, printing component, vibrating component, etc.

I/O ports 818 allow computing device 800 to be logically coupled to other devices including I/O components 820, some of which may be built in. Illustrative components include a microphone, joystick, game pad, satellite dish, scanner, printer, wireless device, etc. The I/O components 820 may provide a natural user interface (NUI) that processes air gestures, voice, or other physiological inputs generated by a user. In some instance, inputs may be transmitted to an appropriate network element for further processing. A NUI may implement any combination of speech recognition, touch and stylus recognition, facial recognition, biometric recognition, gesture recognition both on screen and adjacent to the screen, air gestures, head and eye-tracking, and touch recognition associated with displays on the computing device 800. The computing device 800 may be equipped with depth cameras, such as, stereoscopic camera systems, infrared camera systems, RGB camera systems, and combinations of these for gesture detection and recognition. Additionally, the computing device 800 may be equipped with accelerometers or gyroscopes that enable detection of motion.

The present technology has been described in relation to particular embodiments, which are intended in all respects to be illustrative rather than restrictive. Alternative embodiments will become apparent to those of ordinary skill in the art to which the present technology pertains without departing from its scope.

Having identified various components utilized herein, it should be understood that any number of components and arrangements may be employed to achieve the desired functionality within the scope of the present disclosure. For example, the components in the embodiments depicted in the figures are shown with lines for the sake of conceptual clarity. Other arrangements of these and other components may also be implemented. For example, although some components are depicted as single components, many of the elements described herein may be implemented as discrete or distributed components or in conjunction with other components, and in any suitable combination and location. Some elements may be omitted altogether. Moreover, various functions described herein as being performed by one or more entities may be carried out by hardware, firmware, and/or software, as described below. For instance, various functions may be carried out by a processor executing instructions stored in memory. As such, other arrangements and elements (e.g., machines, interfaces, functions, orders, and groupings of functions) can be used in addition to or instead of those shown.

Embodiments described herein may be combined with one or more of the specifically described alternatives. In particular, an embodiment that is claimed may contain a reference, in the alternative, to more than one other embodiment. The embodiment that is claimed may specify a further limitation of the subject matter claimed.

The subject matter of embodiments of the technology is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

For purposes of this disclosure, the word “including” has the same broad meaning as the word “comprising,” and the word “accessing” comprises “receiving,” “referencing,” or “retrieving.” Further, the word “communicating” has the same broad meaning as the word “receiving,” or “transmitting” facilitated by software or hardware-based buses, receivers, or transmitters using communication media described herein. In addition, words such as “a” and “an,” unless otherwise indicated to the contrary, include the plural as well as the singular. Thus, for example, the constraint of “a feature” is satisfied where one or more features are present. Also, unless indicated otherwise, the term “or” includes the conjunctive, the disjunctive, and both (a or b thus includes either a or b, as well as a and b). Further, the term “and/or” includes the conjunctive, the disjunctive, and both (a and/or b thus includes either a or b, as well as a and b).

For purposes of a detailed discussion above, embodiments of the present technology are described with reference to a distributed computing environment; however, the distributed computing environment depicted herein is merely exemplary. Components can be configured for performing novel embodiments of embodiments, where the term “configured for” can refer to “programmed to” perform particular tasks or implement particular abstract data types using code. Further, while embodiments of the present technology may generally refer to the technical solution environment and the schematics described herein, it is understood that the techniques described may be extended to other implementation contexts.

From the foregoing, it will be seen that this technology is one well adapted to attain all the ends and objects set forth above, together with other advantages which are obvious and inherent to the system and method. It will be understood that certain features and subcombinations are of utility and may be employed without reference to other features and subcombinations. This is contemplated by and is within the scope of the claims.

What is claimed is:

1. One or more computer storage media storing computer-useable instructions that, when used by one or more computing devices, cause the one or more computing devices to perform operations, the operations comprising:
extracting content from a user interface (UI) design file for a UI design generated using an interface design application;
inferring structure data from a screenshot of the UI design;
extracting style data from the UI design file;
generating structure code using the structure data;
generating styling code using the style data; and
storing, in a code repository, the structure code and the styling code as code components for the UI design.

2. The one or more computer storage media of claim 1, wherein the operations further comprise:
rendering a user interface using the extracted content, the structure code, and the styling code.

3. The one or more computer storage media of claim 2, wherein the operations further comprise:
extracting interactivity data from the UI design file; and
wherein rendering the user interface further comprises applying interactivity to one or more elements based on the interactivity data.

4. The one or more computer storage media of claim 1, wherein extracting content from the UI design file comprises:
extracting a plurality of content items from the UI design file; and
separately storing each content item from the plurality of content items in a content storage system.

5. The one or more computer storage media of claim 1, wherein inferring the structure data from the screenshot of the UI design comprises:
causing a first artificial intelligence (AI) agent to generate a layout description from the screenshot of the UI design, the layout description providing text describing a structure of the UI design.

6. The one or more computer storage media of claim 5, wherein the text describing the structure of the UI design provided by the layout description includes: text identifying elements in the UI design, text identifying relationships among the elements, and text identifying a role of each of the elements in the UI design.

7. The one or more computer storage media of claim 5, wherein generating the structure code using the structure data comprises:
causing a second AI agent to generate a decorator function based on the layout description and an input block of hypertext markup language (HTML), wherein the structure code comprises the input block of HTML and the decorator function.

8. The one or more computer storage media of claim 7, wherein the decorator function is generated to modify the input block of HTML by adding classes, restructuring elements, and implementing functionalities.

9. The one or more computer storage media of claim 7, wherein generating the styling code using the style data further comprises:
causing a third AI agent to generate the styling code using the style data, the layout description, the input block of HTML, and the decorator function.

10. A computer-implemented method comprising:
extracting, by a content extraction model, content from a user interface (UI) design file for a UI design generated using an interface design application;
generating, by a first artificial intelligence (AI) agent, a layout description of the UI design based on a screenshot of the UI design;
generating, by a second AI agent, a decorator function based on the layout description;
extracting, by a style module, style data from the UI design file;
generating, by a third AI agent, styling code based on the layout description, the decorator function, and the style data; and
storing, in a code repository, the decorator function and the styling code as code components for the UI design.

11. The computer-implemented method of claim 10, wherein the method further comprises:
rendering a user interface using the extracted content, the decorator function, and the styling code.

12. The computer-implemented method of claim 10, wherein extracting content from the UI design file comprises:
extracting a plurality of content items from the UI design file; and
separately storing each content item from the plurality of content items in a content storage system.

13. The computer-implemented method of claim 10, wherein the layout description comprise text describing a structure of the UI design, include: text identifying elements in the UI design, text identifying relationships among the elements, and text identifying a role of each of the elements in the UI design.

14. The computer-implemented method of claim 10, wherein the decorator function is generated based on the layout description and input hypertext markup language (HTML), wherein the decorator function is configured to modify the input HTML by adding classes, restructuring elements, and implementing functionalities.

15. A computer system comprising:
a content storage system storing a plurality of content items;
a code repository storing a plurality of code components for user interfaces; and
a code conversion system, the code conversion system comprising:
a content extraction module that extracts content items from UI design files and stores the content items in the content storage system;
a structure module that generates structure code components from screenshots of UI designs for the UI design files; and
a style module that extracts style data from the UI design files and generates styling code components based on the style data.

16. The computer system of claim 15, wherein the structure module generates the structure code components from the screenshots of the UI designs for the UI design files by:
causing a first artificial agent (AI) agent to generate layout descriptions from the screenshots of the UI design.

17. The computer system of claim 16, each layout description comprises: text identifying elements in a corresponding UI design, text identifying relationships among the elements, and text identifying a role of each of the elements in the corresponding UI design.

18. The computer system of claim 16, wherein the structure module generates the structure code components from the screenshots of the UI designs for the UI design files by:
causing a second AI agent to generate decorator functions based on the layout descriptions, wherein the structure code components comprise the decorator functions.

19. The computer system of claim 18, wherein the decorator functions are generated to modify input blocks of HTML by adding classes, restructuring elements, and implementing functionalities.

20. The computer system of claim 19, wherein the style module generates the styling code components based on the style data by:
causing a third AI agent to generate the styling code components using the style data, the layout descriptions, the input blocks of HTML, and the decorator functions.
